(19) United States
(12) Patent Application Publication
(10) Pub. No.: US 2023/0085938 A1
(43) Pub. Date: Mar. 23, 2023

(54) VISUAL ANALYTICS SYSTEMS TO DIAGNOSE AND IMPROVE DEEP LEARNING MODELS FOR MOVABLE OBJECTS IN AUTONOMOUS DRIVING

(71) Applicant: Robert Bosch GmbH, Stuttgart (DE)

(72) Inventors: Wenbin HE, Sunnyvale, CA (US); Liang GOU, San Jose, CA (US); Lincan ZOU, San Jose, CA (US); Liu REN, Saratoga, CA (US)

(21) Appl. No.: 17/477,680

(22) Filed: Sep. 17, 2021

(51) Int. Cl. G06N 3/08; G06N 3/04

(52) U.S. Cl. CPC G06N 3/088; G06N 3/0454

(57) ABSTRACT

Embodiments of systems and methods for diagnosing an object-detecting machine learning model for autonomous driving are disclosed herein. An input image is received from a camera mounted in or on a vehicle that shows a scene. A spatial distribution of movable objects within the scene is derived using a context-aware spatial representation machine learning model. An unseen object is generated in the scene that is not originally in the input image utilizing a spatial adversarial machine learning model. Via the spatial adversarial machine learning model, the unseen object is moved to different locations to fail the object-detecting machine learning model. An interactive user interface enables a user to analyze performance of the object-detecting machine learning model with respect to the scene without the unseen object and the scene with the unseen object.

### TECHNICAL FIELD

The present disclosure relates to visual analytics systems to diagnose and improve deep learning models for movable objects in autonomous driving.

### BACKGROUND

Autonomous driving allows a vehicle to be capable of sensing its environment and moving safely with little or no human input. Many systems make autonomous driving possible. One such system is semantic segmentation. Semantic segmentation involves taking an image from a camera mounted in or on the vehicle, partitioning the input image into semantically meaningful regions at the pixel level, and assigning each region with a semantic label such as pedestrian, car, road, and the like.

Deep convolutional neural networks (CNNs) have been playing an increasingly important role in perception systems for autonomous driving, including object detection and semantic segmentation. Despite superior performance of CNNs, a thorough evaluation of the model's accuracy and robustness is required before deploying them to autonomous vehicles due to safety concerns. On one hand, the models' accuracy should be analyzed over objects with numerous semantic classes and data sources to fully understand when and why the models might tend to fail. On the other hand, identifying and understanding models' potential vulnerabilities are crucial to improve models' robustness against unseen driving scenes.

### SUMMARY

According to an embodiment, a computer-implemented method for diagnosing an object-detecting machine learning model for autonomous driving is provided. The computer-implemented method includes: receiving an input image from a camera showing a scene; deriving a spatial distribution of movable objects within the scene utilizing a context-aware spatial representation machine learning model; generating an unseen object in the scene that is not in the input image utilizing a spatial adversarial machine learning model; via the spatial adversarial machine learning model, moving the unseen object to different locations to fail the object-detecting machine learning model; and outputting an interactive user interface that enables a user to analyze performance of the object-detecting machine learning model with respect to the scene without the unseen object and the scene with the unseen object.

According to an embodiment, a system for diagnosing an object-detecting machine learning model for autonomous driving with human-in-the-loop is provided. The system includes a user interface. The system includes memory storing an input image received from a camera showing a scene external to a vehicle, the memory further storing program instructions corresponding to a context-aware spatial representation machine learning model configured to determine spatial information of objects within the scene, and the memory further storing program instructions corresponding to a spatial adversarial machine learning model configured to generate and insert unseen objects into the scene. The system includes a processor communicatively coupled to the memory and programmed to: generate a semantic mask of the scene via semantic segmentation, determine a spatial distribution of movable objects within the scene based on the semantic mask utilizing the context-aware spatial representation machine learning model, generate an unseen object in the scene that is not in the input image utilizing the spatial adversarial machine learning model, move the unseen object to different locations utilizing the spatial adversarial machine learning model to fail the object-detecting machine learning model, and output, on the user interface, visual analytics that allows a user to analyze performance of the object-detecting machine learning model with respect to the scene without the unseen object and the scene with the unseen object.

According to an embodiment, a system includes memory storing (i) an input image received from a camera showing a scene external to a vehicle, (ii) a semantic mask associated with the input image, (iii) program instructions corresponding to a context-aware spatial representation machine learning model configured to determine spatial information of objects within the scene, and (iv) program instructions corresponding to a spatial adversarial machine learning model configured to generate and insert unseen objects into the scene. The system includes one or more processors in communication with the memory and programmed to, via the context-aware spatial representation machine learning model, encode coordinates of movable objects within the scene into latent space, and reconstructing the coordinates with a decoder to determine a spatial distribution of the movable objects. The one or more processors is further programmed to, via the spatial adversarial machine learning model, generate an unseen object in the scene that is not in the input image by (i) sampling latent space coordinates of a portion of the scene to map a bounding box, (ii) retrieving from the memory an object with similar bounding box coordinates, and (iii) placing the object into the bounding box. The one or more processors is further programmed to, via the spatial adversarial machine learning model, move the unseen object to different locations utilizing the spatial adversarial machine learning model in an attempt to fail the object-detecting machine learning model. The one or more processors is further programmed to output, on a user interface, visual analytics that allows a user to analyze performance of the object-detecting machine learning model with respect to the scene without the unseen object and the scene with the unseen object.

### BRIEF DESCRIPTION OF THE DRAWINGS

FIG. 1 is a schematic diagram of a system that performs visual analytics tools and their underlying machine learning models, according to an embodiment.

FIG. 2 is a schematic of a machine learning model that produces a prediction mask from an input image, according to an embodiment.

FIG. 3 is a schematic overview of a system configured to diagnose and improve the accuracy and robustness of semantic segmentation models with respect to movable objects, according to an embodiment.

FIG. 4 is a schematic of a context-aware spatial representation machine learning model, according to an embodiment.

FIG. 5 is a schematic of a spatial adversarial machine learning model, according to an embodiment.

FIG. 6 is a schematic of a system configured to output a MatrixScape view or region on a user interface, according to an embodiment.

FIG. 7 is a performance landscape view of a semantic segmentation model for urban driving scenes as an example of the MatrixScapes view visible on the user interface, according to an embodiment.

FIG. 8 is a block view of a comparison of two datasets, in this case a training or original dataset and adversarial dataset wherein each block can be expanded to see images that are represented by the block, according to an embodiment.

FIG. 9 is a flowchart of a method or algorithm implemented by the processor(s) disclosed herein.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

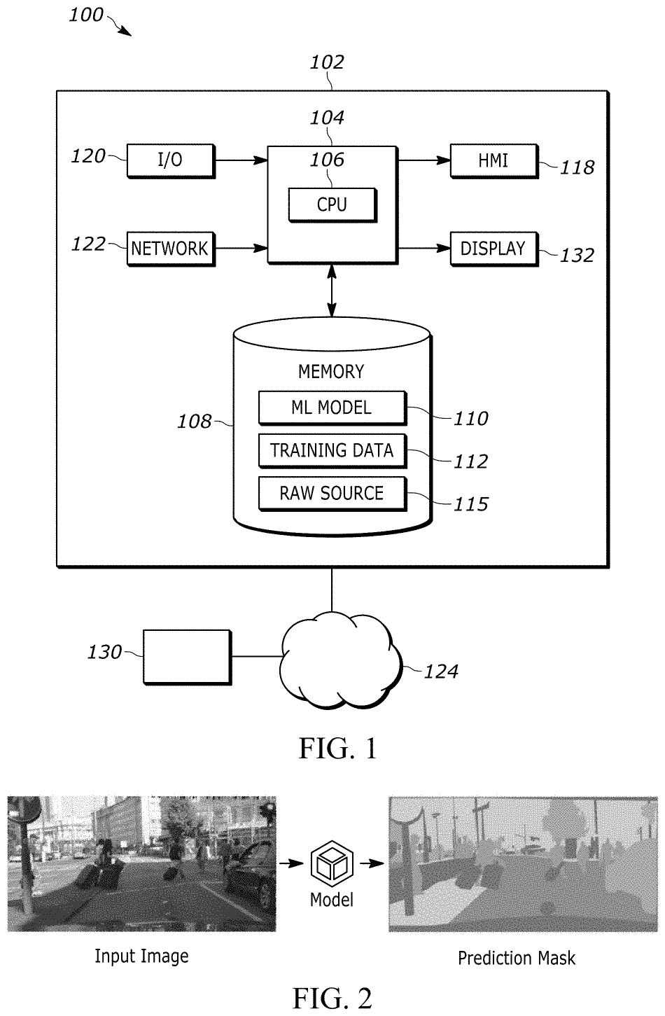

Autonomous vehicles need to perceive and understand driving scenes to make the right decisions. Semantic segmentation is commonly used in autonomous driving systems to recognize driving areas and detect important objects on the road, such as pedestrians, cars, and others. While semantic segmentation can be used in various technologies—i.e., not just images—this disclosure focuses on the semantic segmentation of image data, which partitions images (e.g., taken from a camera mounted in or on the vehicle) into semantically meaningful regions at the pixel level, and classifies each segment into a class (e.g., road, pedestrian, vehicle, car, building, etc.). FIG. 1 shows an example of semantic segmentation at work. An input image is fed into one or more machine learning models, which output a prediction mask. The prediction mask is an image that partitions the various items seen in the input image into multiple segments, and classifies each segment into a class. Like classes can be colored or shaded with like colors or shades. Semantic segmentation allows the autonomous vehicle systems to better understand what objects are around the vehicle so that the vehicle can be controlled to drive safely.

Current visual analytics solutions for autonomous driving mostly focus on object detection, and semantic segmentation models are less studied in this domain. It is challenging to evaluate and diagnose when and why semantic segmentation models may fail to detect critical objects. There is usually massive datasets to test, and thus it is challenging to quickly identify failure cases and diagnose the root cause of these errors, especially related to scene context. For example, a pedestrian may be missed by the semantic segmentation models because he is wearing clothing with similar colors as a traffic cone in the context. Further, although a model sees most objects in their usual context, such as pedestrians in open areas and sidewalks, there are some previously unseen context-dependent locations, such as a person between a truck and a post, that may fail to be detected by the semantic segmentation model. It is challenging to reveal these potential risks and evaluate the object detector's spatial robustness over these edge cases.

Deep convolutional networks (CNNs) have been playing an increasingly important role in perception systems for autonomous driving, such as object detection and semantic segmentation. Despite the superior performance of CNNs, a thorough evaluation of them is required before deploying them to autonomous vehicles due to safety concerns, for which visual analytics is widely used to analyze, interpret, and understand the behavior of complex CNNs. Some visual analytics approaches have been proposed to analyze CNNs, which mainly focus on model interpretation and diagnosis. Model interpretation aims to open the black box of CNNs by either visualizing the neurons and feature maps directly or utilizing explainable surrogate models (e.g., linear models). Model diagnosis focuses on assessing and understanding models' performance by summarizing and comparing models' prediction results and analyzing potential vulnerabilities.

In embodiments disclosed herein, the system first learns a context-aware spatial representation of objects, such as position, size, and aspect ratio, from given driving scenes. With this spatial representation, the system can (1) estimate the distribution of objects' spatial information (e.g., possible positions, sizes, and aspect ratios) in different driving scenes, (2) summarize and interpret models' performance with respect to objects' spatial information, and (3) generate new test cases by properly inserting new objects into driving scenes by considering scene contexts. In embodiments, the system also then uses adversarial learning to efficiently generate unseen test examples by perturbing or changing objects' position and size within the learned spatial representations. Then, a visual analytics system visualizes and analyzes the models' performance over both natural and adversarial data and derives actionable insights to improve the models' accuracy and spatial robustness. All this is done in an interactive visual analytics system that can be operated by a human.

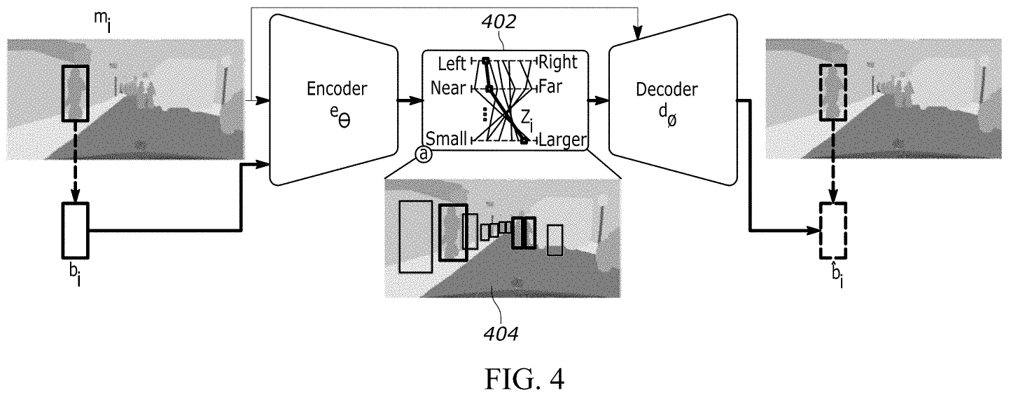

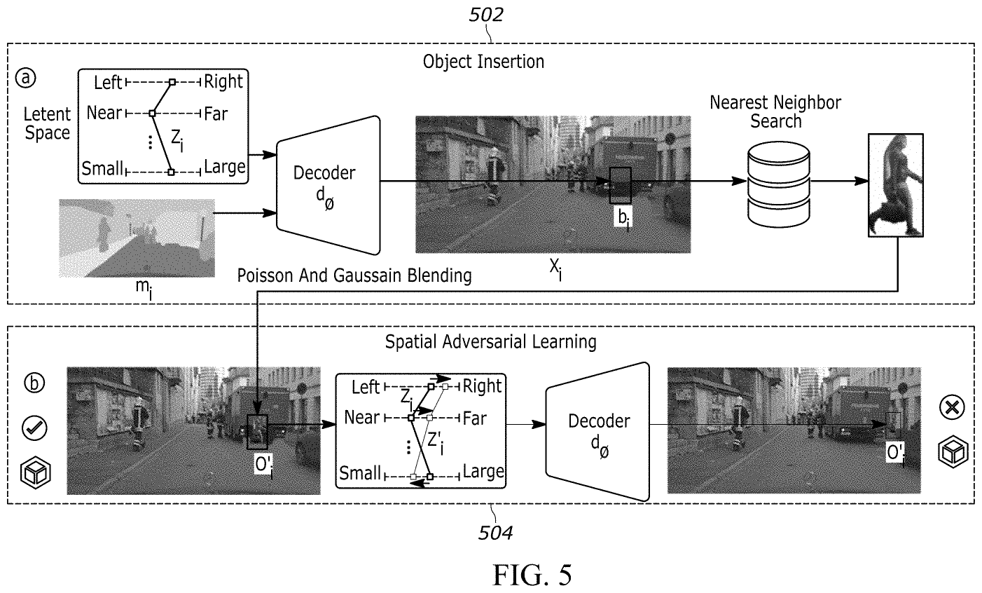

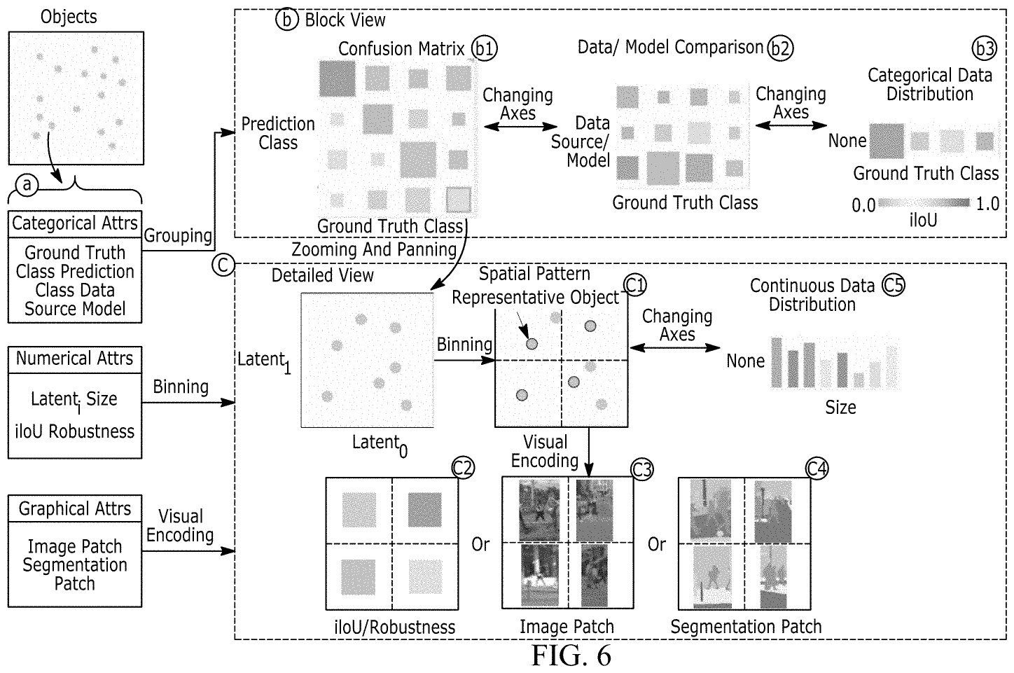

In more particular terms, and as will be described further below with respect to the Figures, a visual analytic system is disclosed herein for assessing, interpreting, and improving a semantic segmentation models for critical object detection in autonomous driving. The visual analytic system uses context-aware representation learning (FIG. 4) to learn the spatial distribution of moveable objects in a given scene. The model learns spatial information by encoding the bounding box coordinates into a low-dimension latent space and then reconstructing the boxes with a decoder. The system also uses the semantic mask as a conditional input to force the spatial distribution to depend on the scene context. In this way, the latent dimensions capture interpretable spatial distributions of movable objects. This helps the system provide a visual tool to a user to help visually understand information about the object, such as its position (e.g., left to right, or close to far away). It also helps interpret the object's overall performance. As will be described, the system also includes a spatial adversarial machine learning model (FIG. 5) to generate unseen objects at different locations within a context and test the model robustness. Given a driving scene, the system can generate another moveable object to fail the detector by small meaningful changes of its location. This can be done by sampling a possible location for an object form the spatial latent space. This location is conditioned on the given scene mask. The latent dimensions can be changed to generate a new location that can fail the detector. An adversarial gradient estimation can achieve this. The minimal amount of change over latent dimensions can indicate the spatial robustness. With the original data and the generated adversarial data, the visual analytics system can produce user interfaces to enable a human to analyze and improve the semantic segmentation models (FIGS. 6-8). These Figures will be described in more detail below.

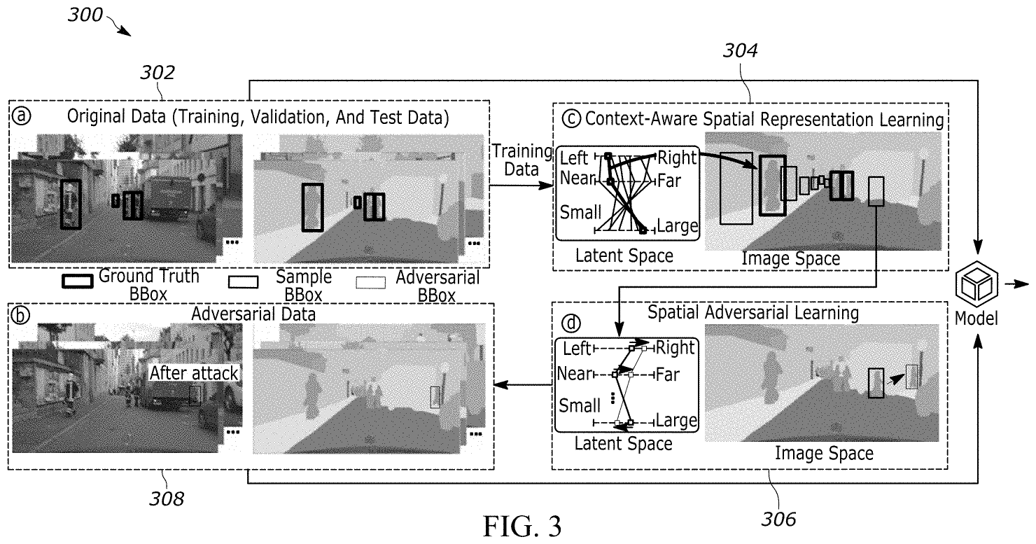

FIG. 2 depicts an overall system 100 capable of and configured to carry out the systems disclosed herein, including the visual analytics tools and their underlying machine learning models. The system 100 may include at least one computing system 102. The computing system 102 may include at least one processor 104 that is operatively connected to a memory unit 108, or memory. The processor 104 may include one or more integrated circuits that implement the functionality of a central processing unit (CPU) 106. The CPU 106 may be a commercially available processing unit that implements an instruction stet such as one of the x86, ARM, Power, or MIPS instruction set families. During operation, the CPU 106 may execute stored program instructions that are retrieved from the memory unit 108. The stored program instructions may include software that controls operation of the CPU 106 to perform the operation described herein. In some examples, the processor 104 may be a system on a chip (SoC) that integrates functionality of the CPU 106, the memory unit 108, a network interface, and input/output interfaces into a single integrated device. The computing system 102 may implement an operating system for managing various aspects of the operation.

The memory unit 108 may include volatile memory and non-volatile memory for storing instructions and data. The non-volatile memory may include solid-state memories, such as NAND flash memory, magnetic and optical storage media, or any other suitable data storage device that retains data when the computing system 102 is deactivated or loses electrical power. The volatile memory may include static and dynamic random-access memory (RAM) that stores program instructions and data. For example, the memory unit 108 may store a machine-learning model 110 or algorithm, a training dataset 112 for the machine-learning model 110, and raw source dataset 115.

The computing system 102 may include a network interface device 122 that is configured to provide communication with external systems and devices. For example, the network interface device 122 may include a wired and/or wireless Ethernet interface as defined by Institute of Electrical and Electronics Engineers (IEEE) 802.11 family of standards. The network interface device 122 may include a cellular communication interface for communicating with a cellular network (e.g., 3G, 4G, 5G). The network interface device 122 may be further configured to provide a communication interface to an external network 124 or cloud.

The external network 124 may be referred to as the world-wide web or the Internet. The external network 124 may establish a standard communication protocol between computing devices. The external network 124 may allow information and data to be easily exchanged between computing devices and networks. One or more servers 130 may be in communication with the external network 124. The one or more servers 130 may have the memory and processors configured to carry out the systems disclosed herein.

The computing system 102 may include an input/output (I/O) interface 120 that may be configured to provide digital and/or analog inputs and outputs. The I/O interface 120 may include additional serial interfaces for communicating with external devices (e.g., Universal Serial Bus (USB) interface).

The computing system 102 may include a human-machine interface (HMI) device 118 that may include any device that enables the system 100 to receive control input. Examples of input devices may include human interface inputs such as keyboards, mice, touchscreens, voice input devices, and other similar devices. The computing system 102 may include a display device 132. The computing system 102 may include hardware and software for outputting graphics and text information to the display device 132. The display device 132 may include an electronic display screen, projector, printer or other suitable device for displaying information to a user or operator, and allow the user to act as a human-in-the-loop operator to interactively diagnose the machine learning models via the visual analytics system. The computing system 102 may be further configured to allow interaction with remote HMI and remote display devices via the network interface device 122. The HMI 118 and display 132 may collectively provide a user interface (e.g., the visual component to the analytics system) to the user, which allows interaction between the human user and the processor(s) 104.

The system 100 may be implemented using one or multiple computing systems. While the example depicts a single computing system 102 that implements all of the described features, it is intended that various features and functions may be separated and implemented by multiple computing units in communication with one another. The particular system architecture selected may depend on a variety of factors, and the system illustrated in FIG. 1 is merely an example.

The system 100 may implement a machine-learning algorithm 110 that is configured to analyze the raw source dataset 115. The raw source dataset 115 may include raw or unprocessed sensor data or image data that may be representative of an input dataset for a machine-learning system. The raw source dataset 115 may include video, video segments, images, text-based information, and raw or partially processed sensor data (e.g., radar map of objects). In some examples, the machine-learning algorithm 110 may be a neural network algorithm that is designed to perform a predetermined function. For example, the neural network algorithm may be configured in automotive applications to identify items (e.g., pedestrians, signs, buildings, sky, road, etc.) in images or series of images (e.g., video), and even annotate the images to include labels of such items. The machine-learning algorithm 110 may rely on or include CNNs (for example) to perform these functions.

The computer system 100 may store a training dataset 112 for the machine-learning algorithm 110. The training dataset 112 may represent a set of previously constructed data for training the machine-learning algorithm 110. The training dataset 112 may be used by the machine-learning algorithm 110 to learn weighting factors associated with a neural network algorithm. The training dataset 112 may include a set of source data that has corresponding outcomes or results that the machine-learning algorithm 110 tries to duplicate via the learning process. In this example, the training dataset 112 may include source images or videos with and without items in the scene and corresponding presence and location information of the item.

The machine-learning algorithm 110 may be operated in a learning mode using the training dataset 112 as input. The machine-learning algorithm 110 may be executed over a number of iterations using the data from the training dataset 112. With each iteration, the machine-learning algorithm 110 may update internal weighting factors based on the achieved results. For example, the machine-learning algorithm 110 can compare output results (e.g., annotations, latent variables, adversarial noise, etc.) with those included in the training dataset 112. Since the training dataset 112 includes the expected results, the machine-learning algorithm 110 can determine when performance is acceptable. After the machine-learning algorithm 110 achieves a predetermined performance level (e.g., 100% agreement with the outcomes associated with the training dataset 112), the machine-learning algorithm 110 may be executed using data that is not in the training dataset 112. The trained machine-learning algorithm 110 may be applied to new datasets to generate annotated data.

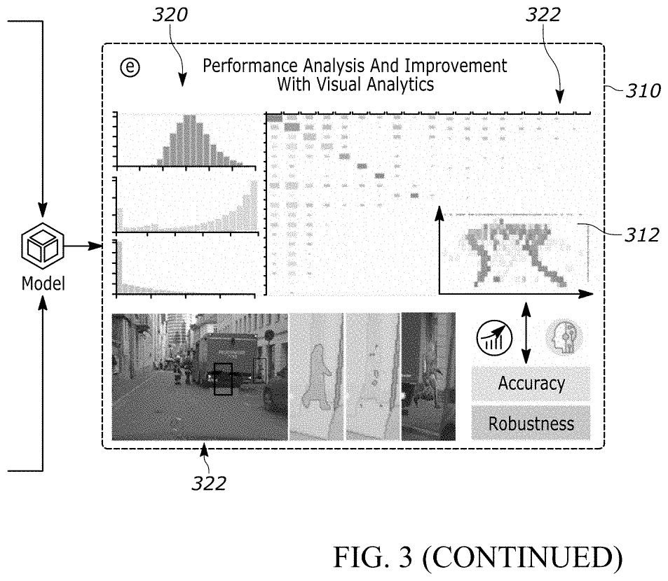

FIG. 3 provides an overview of a visual analytics system 300 configured to diagnose and improve the accuracy and robustness of semantic segmentation models with respect to movable objects. In general, the system 300 includes both a context-aware spatial adversarial machine learning model and a spatial adversarial machine learning model to produce an interactive visual analytics system. The system 300 uses original data at 302 which includes ground truth boundary boxes placed over detected objects, and a corresponding mask created from the original data pursuant to the methods described herein. The system 300 uses a context-aware representation learning model 304 to learn the spatial distribution of movable objects in a given scene. The system 300 also uses a spatial adversarial machine learning model 306 which generates unseen objects at different locations within a context (e.g., adversarial data 308) to test the model robustness. With the original data 302 and the generated adversarial data 308, the system 300 produces an interactive visual analytic user interface 310 to allow a user to analyze and improve semantic segmentation models with human-in-the-loop with respect to the overall system 300. Each of the context-aware spatial adversarial machine learning model 304, the spatial adversarial machine learning model 306, and the interactive visual analytic user interface 310 will be described further below.

The context-aware spatial adversarial machine learning model 304 is shown in more detail in FIG. 4. The context-aware spatial adversarial machine learning model 304 learns spatial information by first encoding (e.g., via encoder) the bounding box coordinates into a low-dimension latent space, and then reconstructing the boxes with a decoder. In particular, the model 304 is configured to extract a latent representation of the movable objects' spatial information—such as position, size, and aspect ratio—conditioned on given driving scenes. A conditional variational autoencoder (CVAE) is adapted to perform context-aware spatial representation learning, which includes two main components: an encoder e_{θ} and a decoder d_{φ}, where θ and φ are weights of respective deep neural networks. Given an object with in a driving scene, its bounding box bᵢ=[xᵢ^{min}, tᵢ^{min}, xᵢ^{max}, yᵢ^{max}] is encoded into a latent vector zᵢ 402 via the encoder, with the driving scene's ground truth segmentation (e.g., a mask with a semantic class label at each pixel position), mᵢ, as the condition. The latent vector zᵢ is then mapped into a reconstructed bounding box \hat{b}ᵢ using the decoder d_{φ}, which is also conditioned on the semantic segmentation mask mᵢ. The condition input mᵢ thus enables the model to learn context-aware spatial representation. In other words, the semantic mask is used as conditional input to force the spatial distribution to depend on the scene context. In this way, the latent dimensions capture interpretable spatial distributions of movable objects.

In one embodiment, the CVAE may be trained with two losses, include a reconstruction loss [symbol] ᵣ and a latent loss [symbol] ₗ. The reconstruction loss is used to measure the difference between the input bounding box bᵢ and the reconstructed bounding box \hat{b}ᵢ, for which the mean abosolute error between bᵢ and \hat{b}ᵢ is determined as

$${ℓ}_{r} = \frac{\vert {b}_{i} - {\hat{b}}_{i} \vert}{4} .$$

The latent loss can be the Kullback-Leibler divergence D_{KL} between the approximated posterior distribution and the Gaussian prior. The trainer can use β-VAE to disentangle the latent representations, which combines the reconstruction loss and [symbol] ᵣ the latent loss [symbol] ₗ with a weight β, namely [symbol] = [symbol] ᵣ+β [symbol] ₗ. In an embodiment discovered through experiments, β can be set to 2e-3 to balance the reconstruction accuracy and the disentanglement of the latent representations.

After training, the encoder and the decoder can be used for data summarization and generation. With the encoder, each boundary box can be mapped into a latent vector 402 that captures its spatial information, such as position and size relative to the driving scene. The dimensions of the latent vectors also have semantic meanings, such as left to right, near to far, and small to large. This is shown as an example at 312 which can be provided within or part of the interactive visual analytic user interface 310, in which the y-axis may be a first latent dimension of how near or far the object is, and the x-axis may be a second latent dimension of left to right. The latent vectors are used to summarize the performance of semantic segmentation models with respect to objects' spatial information. Given samples drawn from the latent space, the decoder can generate objects' possible positions and sizes (e.g., bounding boxes shown within mask 404) in given driving scenes, which are used to guide the generation of adversarial examples for the robustness test.

Referring back to FIG. 3, regarding the spatial adversarial machine learning model 306, the goal of the spatial adversarial machine learning model 306 is: given a driving scene, generate another moveable object to fail the detector by changes in its location adversarial examples can be generated based on the learned spatial representation in order to test and improve the robustness of semantic segmentation models. The adversarial examples can be generated via two steps: (1) properly inserting a new object into a driving scene in a semantically consistent manner, and (2) perturbing the latent representation to adjust the object's spatial transformation (e.g., position and size) in the scene to fool the target model via adversarial learning. These two steps are shown in FIG. 5, which is a more detailed view of the spatial adversarial machine learning model 306. In particular, the first step (e.g., objection insertion 502) includes obtaining a context-aware possible position of an object by sampling the learned spatial latent space to insert a new object. The second step (e.g., spatial adversarial learning 504) includes perturbing the object's position and size to fail the model by searching the latent space with adversarial learning.

Regarding object insertion 502, given a driving scene, the system properly inserts a new object into the scene for adversarial search. Existing objects are not changed or moved in the scene to avoid introducing unnecessary artifacts. To make the inserted object conform to the scene semantics (e.g., pedestrians should not be placed in the sky), the learned spatial representation is leveraged to sample a possible position. For example, as shown in 502, first a sample zᵢ is drawn from the latent space and mapped into a bounding box b using the decoder d_{φ} and the semantic segmentation mask mᵢ of the target driving scene xᵢ. Then, all training data (e.g., stored in the memory described herein) is searched to find an object that has the most similar bounding box with the generated box and the retrieved object is scaled and translated to fit into bounding box bᵢ. The reason or selecting an object with a similar bounding box is to keep the fidelity of the object after scaling and translation. To blend the new object into the driving scene seamlessly, Poisson blending may be used to match the color and illumination of the object with the surrounding context. Meanwhile, Gaussian blurring may be applied on the boundary of the object to mitigate the boundary artifacts.

Regarding spatial adversarial learning 504, this is conducted to properly and efficiently move the inserted object in the scene so that the overall object-detecting machine learning model fails to properly detect it. The idea is to perturb the inserted object's spatial latent representation to find the fastest way to move the object to fool the target model. Specifically, in an embodiment, given a driving scene xᵢ with an object oᵢ placed in a bounding box b the adversarial example is generated by searching for a new bounding box b′₁ to place the object such that the model f fails to predict the transformed object's segmentation correctly. To determine whether the model fails, it is evaluated on the new scene x′ᵢ with the transformed object o′₁ and compared with the new semantic segmentation mask m′ᵢ. The model performance of the transformed object o′ᵢ is then computed and compared with a model-performance threshold, and the model fails if the model performance is less than the model-performance threshold.

To make sure the new bounding box b′ᵢ is semantically meaningful with respect to the driving scene, the system can perform the adversarial search in the latent space instead of manipulating the bounding box directly. To find a latent vector z′ᵢ with a minimal change that produces an adversarial example, the system can adopt the black-box attach method such that the architecture of the semantic segmentation model is not required to be known explicitly. First, a gradient estimation approach is used with natural evolution strategies to find the gradient direction in the latent space that makes the model performance drop at the fastest pace. Then the latent vector zᵢ can be moved along the gradient direction iteratively with a predefined step size until the model performance is smaller than the threshold. While moving the object, only the Gaussian blurring need be applied to blend the object with the driving scene because the focus should be placed on the model's performance change caused by the change of object's spatial information rather than the color shift introduced by Poisson blending.

With the adversarial examples, the system can interpret the robustness of a target model. To this end, a spatial robustness score sᵣᵢ, is defined for each object oᵢ as the mean absolute error between the latent vectors zi and z′₁ normalized by the standard deviation of each latent dimension, namely srᵢ=|zᵢ−z′ᵢ|/|z_{std}|. This score captures how much change in the latent space is needed to fail the model.

After the data preprocessing (e.g., representation and adversarial learning), the system can collect the original (namely, training, validation, and test) and adversarial data along with the model's prediction to drive the visual analytics system's user interface provided to the user. Specifically, for each object, its spatial information (e.g., bounding box, size, latent representation) is extracted, and performance metrics (e.g., model performance, ground truth class, and prediction class) is extracted. In an embodiment, the pixels of an object could be predicted as different classes, for which the object's prediction class is defined as the class with the maximum number of pixels. For the adversarial learning, the robustness and the gradient direction can be extracted to analyze the attack patterns.

Referring back to FIG. 3, with the original data 302 and the generated adversarial data 308, the system can present the visual analytics system's user interface 310 to the user via the HMI device 118, display 132, and the like. The user interface 310 shown in FIG. 3 is a general overview or schematic of how the user interface may appear on screen for the user. In general, there are three regions for interaction and viewing by the user: a summary region 320, a MatrixScape region 322, as well as the driving scene region 324, as detailed below. Each of these regions can be provided on a single window or pane on the display 132, or each region can be moved around or minimized such that the user can customize when and where each region is shown on the user interface.

The summary region 320 includes a summarization of data configurations and statistics of objects' key properties. Data shown can include basic configurations of the data including the data splits, the instance classes, and the models of interest. In addition, bar charts are used to show histogram of objects' key properties including the size of the object developed (top chart), the model performance (middle chart), and the model robustness (bottom chart). The summary region 320 provides an overview of models' performance and enables user to filter data for detailed analysis in the MatrixScape region 322. For example, the user can select various instance classes (e.g., pedestrian, car, truck, bus, train, building, etc.) within the summary region which interactively updates the data displayed in the MatrixScape region 322. Also, users can brush on the bar charts to further filter the data by limiting the range of object size, model performance, and/or robustness.

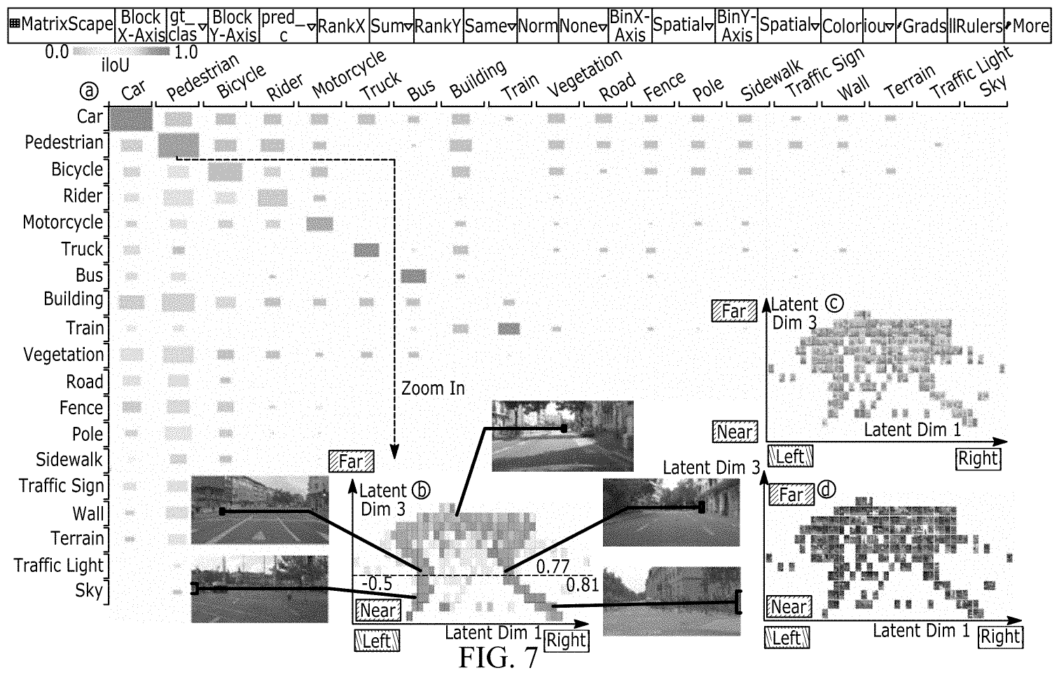

The MatrixScape region 322 is shown in more detail in FIGS. 6-7. The MatrixScape region 322 shows the performance landscape of numerous objects from different aspects of data attributes (FIG. 6, region a) and at different levels of detail (FIG. 6, regions b and c). This view is designed to help users identify interesting subsets of data by comparing models' performance across different semantic classes, data sources, and model versions, as well as understand models' performance over objects' spatial information within the context.

FIG. 6 shows a schematic of the design of the MatrixScape region 322, according to an embodiment. Objects with different types of attributes (a) are first grouped based on different categorical attributes and visualized as a matrix of blocks (b). The objects may be partitioned into groups to provide an overview of the objects' performance with respect to user selected categorical attributes such as ground truth/prediction class, data source, or model version. For example, while grouping the objects based on their ground truth classes (e.g., pedestrian, car, etc.) and prediction classes, the users can have a confusion matrix view (b1) of the model performance, where the size of each block represents the number of objects within it and the color represents the average model performance or robustness score of those objects. Users can compare models' performance across different data sources or model versions in a data/model comparison (b2) which organizes the ground truth class by data source or model. Users can also group the objects based on only one categorical attribute to visual the data distribution (b3). For example, the distribution of objects' classes can be obtained by grouping the objects based on the ground truth class as shown in (b3).

After identifying interesting data blocks within the matrixes, the user can highlight or select any one of the boxes for a more detailed view. FIG. 6 shows an example in which the user has selected the bottom-right box of the confusion matrix (b1), representing the model's performance of a certain ground truth class and a certain prediction class. The result is the MatrixScape view providing a more detailed view (c). The objects shown in the detailed view aggregated into bins based on the numerical attributes (c1) such as the learned latent representation, size, and model performance. Similar to the block view in (b), users can change the numerical attributes to aggregate the objects. For example, users can select two of the latent dimension and use the objects' latent representation on these dimensions to aggregate the objects. After aggregation, the spatial pattern of models' performance can be visualized by selecting a representative object for each bin and visualizing the object using different visual encodings or representations, such as model performance or robustness (c3), image patch (c3), and semantic segmentation patch (c4). Users can define how to select the representative object of each bin. Moreover, when using only one numerical attribute, the data distribution of the select attribute can be visualized (e.g., in a histogram) for each block (c5).

FIG. 7 shows an example of a performance landscape view of a semantic segmentation model for urban driving scenes as an example of the MatrixScapes view. The block view (a) is organized as a confusion matrix based on the objects ground truth and prediction classes. In this example, the classes (both ground truth and prediction) include car, pedestrian, bicycle, rider, motorcycle, truck, bus, building, train, vegetation, road, fence, pole, sidewalk, traffic sign, wall, terrain, traffic light, and sky. Of course, different, more or less classes may be utilized by the systems disclosed herein. The size of each block represents the number of objects within it and the color represents the average model performance or robustness score of those objects. In this example, the user has selected the box that compares the ground truth class of pedestrian and the prediction class of pedestrian. By selecting this box, the user can be provided with the performance landscape of individual objects visualized in the detailed view (b). In this example, the objects are aggregated based on the two dimensions of the learned spatial representation such that the spatial distribution of the objects can be visualized and summarized. For example, a first dimension (Latent Dim 1) represents pedestrians' horizontal position, and the other dimension (Latent Dim 3) represents the pedestrians' distance to the vehicle. Different visual encodings can be used to visualize the objects, such as performance scores (shown in b) where each color represents the model performance at those latent dimensions, image patch (c), and semantic segmentation patch (d) which facilitates users understandings of the spatial pattern of models' performance. The user can hover over or select any block in the performance score matrix shown in (b), and the user interface can output a street view of the image in which that object is detected, with a bounding box around the object. This allows the user to easily click through different boxes within the matrix shown in (b) and see the real image that produced such resulting performance score. The correlation between the latent dements (left to right, and near to far) and the actual position of the detected object is shown by the variety of images selected in FIG. 7.

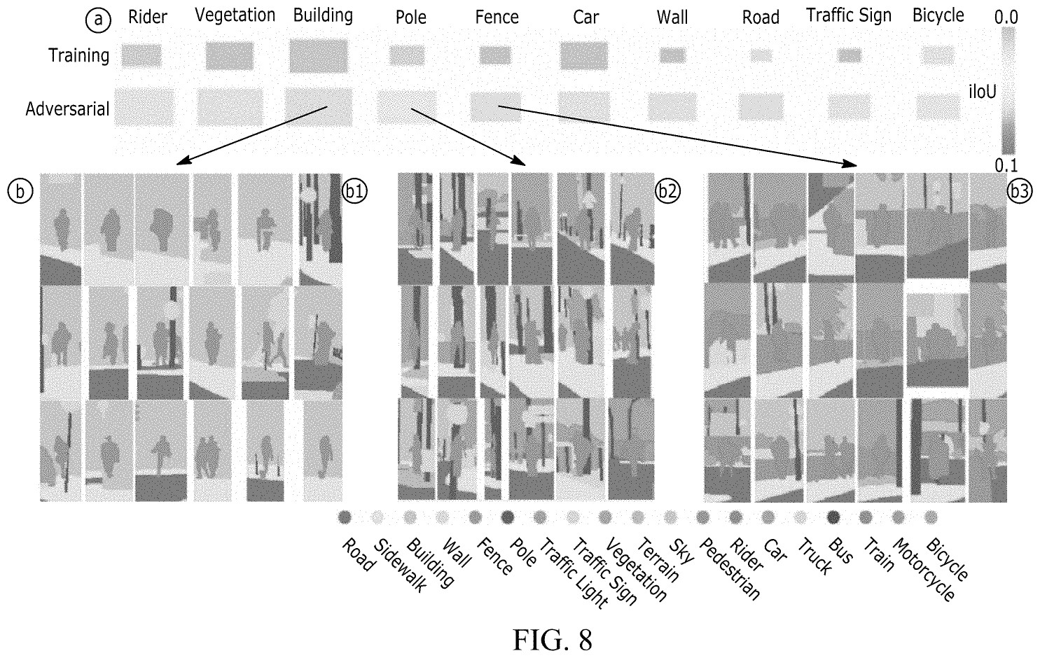

To aid users in comparing the data groups in the block view, the rows and columns can be ranked based on the total number of objects they contain or the variance of the number of objects within the blocks. For example, FIG. 8 shows a block view of the model's performance for pedestrian detection for two datasets, where each row represents a dataset (e.g., a training/original dataset and an adversarial dataset), and each column represents the prediction class of the pedestrians. The columns are ranked based on the difference between the original dataset and the adversarial dataset such that the users can identify the classes that the two datasets differ the most efficiently.

To investigate the model's performance on the segmentation of pedestrians in this illustrated example, the user can see from the block view (a) of FIG. 8 that the adversarial data has more pedestrians being misclassified as specific classes compared with the original/training data, such as rider, vegetation, building, pole, and fence. By zooming or selecting those individual blocks in the adversarial data and visualizing the ground truth segmentations as shown in (b), the user can see that most of the misclassification was caused by interaction between the pedestrian and the surrounding context. For example, the pedestrians were placed in front of buildings, poles, and fences to fail the model. To improve the model's performance for pedestrians interacting with those classes, more pedestrians that interact with those classes can be generated and used to retrain the model.

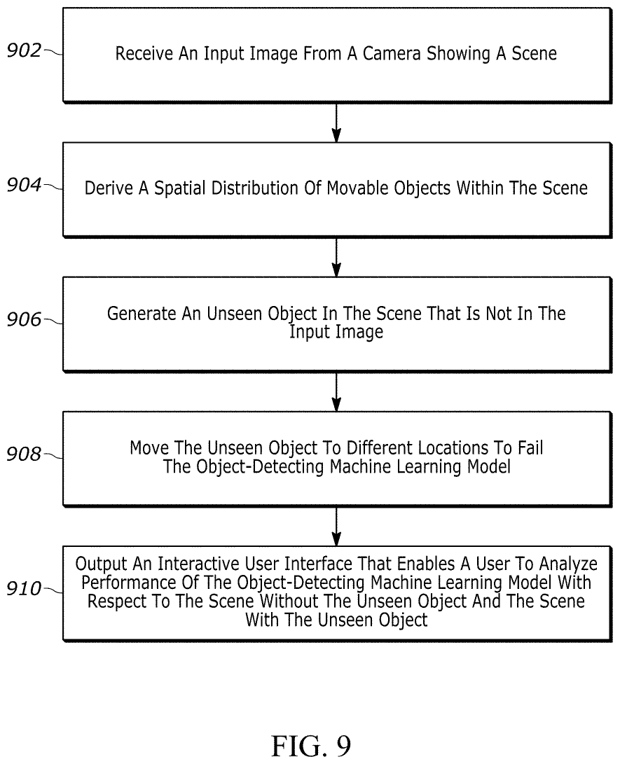

FIG. 9 shows a flowchart that can be implemented by the processor(s) described herein by accessing the stored images, machine learning model program instructions, and the like that are stored in the memory disclosed herein. At 902, an input image is retrieved from the memory. The input image may be a raw image taken from a camera, and/or an associated prediction mask derived from the input image (see FIG. 2 for example). At 904, the processor derives a spatial distribution of movable objects within the scene. This can be done utilizing the context-aware spatial representation machine learning model 304. In doing so, the processor can be programmed to encode coordinates of the movable objects into latent space, and reconstruct the coordinates with a decoder (see FIG. 4, for example). The coordinates of the moving objects may be coordinates of bounding boxes associated with the movable objects that were placed about the objects in the semantic mask. At 906, the processor is programmed to generate an unseen object in the scene that is not in the input image. In other words, a new object that is not shown in the input image as seen by the camera will be inserted into the image. This may be performed utilizing the spatial adversarial machine learning model 306. In doing so, the processor may be programmed to sample latent space coordinates of a portion of the scene to map a bounding box, retrieve from memory an object with similar bounding box coordinates, and place the object into the bounding box (see FIG. 5, for example). At 910, the processor is programmed to move the unseen object to different locations in an attempt to fail the object-detecting machine learning model. This may be done utilizing the spatial adversarial machine learning model by perturbing spatial latent representations of the unseen object, and finding a gradient direction in latent space that corresponds to an adverse performance of the object-detecting machine learning model. In other words, the new object is moved to locations where it is difficult for the object-detecting machine learning model to property identify and classify the new object. At 910, the processor can output an interactive user interface, examples of which are shown in and discussed with reference to FIGS. 6-8.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for diagnosing an object-detecting machine learning model for autonomous driving, the computer-implemented method comprising:
receiving an input image from a camera showing a scene;
deriving a spatial distribution of movable objects within the scene utilizing a context-aware spatial representation machine learning model;
generating an unseen object in the scene that is not in the input image utilizing a spatial adversarial machine learning model;
via the spatial adversarial machine learning model, moving the unseen object to different locations to fail the object-detecting machine learning model; and
outputting an interactive user interface that enables a user to analyze performance of the object-detecting machine learning model with respect to the scene without the unseen object and the scene with the unseen object.

2. The computer-implemented method of claim 1, wherein the step of deriving includes encoding coordinates of the movable objects into latent space, and reconstructing the coordinates with a decoder.

3. The computer-implemented method of claim 2, further comprising generating a semantic mask of the scene, wherein the semantic mask is used as an input to the step of deriving such that the spatial distribution of the movable objects is based on the semantic mask.

4. The computer-implemented method of claim 3, wherein the coordinates of the movable objects are coordinates of bounding boxes associated with the movable objects.

5. The computer-implemented method of claim 4, wherein the coordinates of the bounding boxes are encoded into a latent vector that is conditioned based on semantic class labels of pixels within the semantic mask.

6. The computer-implemented method of claim 1, wherein the step of generating includes (i) sampling latent space coordinates of a portion of the scene to map a bounding box, (ii) retrieving from memory an object with similar bounding box coordinates, and (iii) placing the object into the bounding box.

7. The computer-implemented method of claim 6, further comprising utilizing Poisson blending to blend the object into the scene.

8. The computer-implemented method of claim 1, wherein the step of moving includes perturbing spatial latent representations of the unseen object.

9. The computer-implemented method of claim 8, wherein the step of moving includes finding a gradient direction in latent space that corresponds to performance of the object-detecting machine learning model reducing at a greatest rate.

10. The method of claim 1, wherein the interactive user interface includes a table showing performance of the object-detecting machine learning model with respect to ground truth classes of objects and corresponding predicted classes of the objects.

11. A system for diagnosing an object-detecting machine learning model for autonomous driving with human-in-the-loop, the system comprising:
a user interface;
a memory storing an input image received from a camera showing a scene external to a vehicle, the memory further storing program instructions corresponding to a context-aware spatial representation machine learning model configured to determine spatial information of objects within the scene, and the memory further storing program instructions corresponding to a spatial adversarial machine learning model configured to generate and insert unseen objects into the scene; and
a processor communicatively coupled to the memory and programmed to:
generate a semantic mask of the scene via semantic segmentation,
determine a spatial distribution of movable objects within the scene based on the semantic mask utilizing the context-aware spatial representation machine learning model,
generate an unseen object in the scene that is not in the input image utilizing the spatial adversarial machine learning model,
move the unseen object to different locations utilizing the spatial adversarial machine learning model to fail the object-detecting machine learning model, and
output, on the user interface, visual analytics that allows a user to analyze performance of the object-detecting machine learning model with respect to the scene without the unseen object and the scene with the unseen object.

12. The system of claim 11, wherein the processor is further programmed to encode coordinates of the movable objects into latent space, and reconstruct the coordinates with a decoder to determine the spatial distribution of the movable objects.

13. The system of claim 12, wherein the coordinates of the movable objects are coordinates of bounding boxes associated with the movable objects.

14. The system of claim 13, wherein the coordinates of the bounding boxes are encoded into a latent vector that is conditioned based on semantic class labels of pixels within the semantic mask.

15. The system of claim 11, wherein the processor is further programmed to:
sample latent space coordinates of a portion of the scene to map a bounding box,
retrieve from the memory an object with similar bounding box coordinates, and
place the object in to the bounding box.

16. The system of claim 15, wherein the processor is further programmed to utilize Poisson blending to blend the object into the scene.

17. The system of claim 11, wherein the processor is further programmed to perturb spatial latent representations of the unseen object.

18. The system of claim 17, wherein the processor is further programmed to determine a gradient direction in latent space that corresponds to performance of the object-detecting machine learning model reducing.

19. The system of claim 11, wherein the processor is further programmed to display, on the user interface, a table showing performance of the object-detecting machine learning model with respect to ground truth classes of objects and corresponding predicted classes of the objects.

20. A system comprising:
memory storing (i) an input image received from a camera showing a scene external to a vehicle, (ii) a semantic mask associated with the input image, (iii) program instructions corresponding to a context-aware spatial representation machine learning model configured to determine spatial information of objects within the scene, and (iv) program instructions corresponding to a spatial adversarial machine learning model configured to generate and insert unseen objects into the scene; and
one or more processors in communication with the memory and programmed to:
via the context-aware spatial representation machine learning model, encode coordinates of movable objects within the scene into latent space, and reconstructing the coordinates with a decoder to determine a spatial distribution of the movable objects,
via the spatial adversarial machine learning model, generate an unseen object in the scene that is not in the input image by (i) sampling latent space coordinates of a portion of the scene to map a bounding box, (ii) retrieving from the memory an object with similar bounding box coordinates, and (iii) placing the object into the bounding box,
via the spatial adversarial machine learning model, move the unseen object to different locations utilizing the spatial adversarial machine learning model in an attempt to fail an object-detecting machine learning model, and
output, on a user interface, visual analytics that allows a user to analyze performance of the object-detecting machine learning model with respect to the scene without the unseen object and the scene with the unseen object.
